(19) United States
(12) Patent Application Publication
(10) Pub. No.: US 2026/0349080 A1
(43) Pub. Date: Nov. 5, 2026

(54) LIDAR SYSTEMS AND METHODS

(71) Applicant: NEYE SYSTEMS, INC., Emeryville, CA (US)

(72) Inventors: Ming Chiang A. WU, Piedmont, CA (US); Tae Joon SEOK, El Cerrito, CA (US); Noriaki KANEDA, Westfield, NJ (US); Xiaosheng ZHANG, Davis, CA (US); Kyungmok KWON, El Cerrito, CA (US)

(21) Appl. No.: 19/106,456

(22) PCT Filed: Aug. 28, 2023
(86) PCT No.: PCT/US2023/073026

§ 371 Date: Feb. 25, 2025

Related U.S. Application Data
(60) Provisional application No. 63/373,595, filed on Aug. 26, 2022.
(60) Provisional application No. 63/379,873, filed on Oct. 17, 2022.

(51) Int. Cl. G01S 7/481; G01S 17/89

(52) U.S. Cl. CPC G01S 7/4817; G01S 7/4815; G01S 17/89

(57) ABSTRACT

The present disclosure is directed to imaging LiDARs that can include a FPSA beam scanner and a lens. One or both of the FPSA beam scanner and lens can be moved laterally to increase a lateral resolution of the LiDAR system. Some embodiments can include a microlens disposed between the FPSA beam scanner and the lens. Methods of use are also provided.

### PRIORITY CLAIM

This patent application claims priority to U.S. provisional patent application no. 63/373,595, titled “LIDAR SYSTEMS AND METHODS”, and filed on Aug. 26, 2022, and U.S. provisional patent application no. 63/379,873, titled “LIDAR SYSTEMS AND METHODS INCLUDING CONTINUOUSLY SCANNABLE FOCAL PLANE SWITCH ARRAY”, and filed on Oct. 17, 2022, which are both herein incorporated by reference in their entirety.

### FIELD

The present disclosure details novel LiDAR systems and methods. More specifically, this disclosure is directed to imaging LiDARs.

### BACKGROUND

Light detection and ranging (LiDAR) is widely used in autonomous vehicles and portable devices such as smartphones and tablets. Solid state LiDARs are particularly attractive because they are conducive to miniaturization and mass production. US Patent Pub. No. 2021/0116778 teaches a beam-steering system consisting of a programmable array of vertical couplers (also called optical antennas) located at the focal plane of an imaging lens. Optical signal can be delivered to any selected optical antenna through a programmable optical network consisting of MEMS (micro-electro-mechanical system)-actuated waveguide switches. Compared with conventional thermo-optic or electro-optic switches, the MEMS switches offer lower insertion loss, lower crosstalk, broadband operation, and digital actuation. High density arrays of programmable optical antennas can be integrated on single chips for high resolution imaging LiDARs, thanks to their small footprint.

U.S. Patent Application Ser. No. 17/252,671 teaches, among other things, a beam-steering system comprising a MEMS-actuated vertical coupler array. U.S. Patent Application Ser. No. 17/748,759 teaches, among other things, a MEMS-actuated vertical coupler array with a microlens array to match the chief ray angle of the imaging lens.

In both of the identified systems, an array of optical antennas controlled by MEMS optical switches (called a focal plane switch array) can direct the output light beam to selected directions through an imaging lens. The output beam directions are discrete, corresponding to the discrete array of optical antennas. The angular resolution (difference of adjacent output beam angles) is approximately p/f, where p is the pitch of the optical antenna array, and f is the focal length of the imaging lens. To increase the angular resolution, a smaller array pitch p or a longer focal length f is required. However, the array pitch is limited by footprints of optical antennas and switches, while increasing the lens focal length will also result in a reduction of field of view (beam-steering range). These factors make it difficult to achieve arbitrarily small angular resolution or even continuous beam-steering.

In addition, the laser speckle effect (random intensity distribution of the diffuse reflected light due to the roughness of target surface) can degrade the received signal power stability in a LiDAR system and thus reduce the signal-to-noise ratio. One way to mitigate the speckle effect on received signal power is to slightly change the output beam direction during one LiDAR measurement to effectively detect an average of several different speckle patterns. However, this is not possible in a focal plane switch array with discrete output angles as the output angles cannot be changed arbitrarily.

### SUMMARY

An imaging LiDAR system is provided, comprising: an imaging lens; a light source; a focal plane switch array (FPSA) comprising a plurality of optical antennas, the FPSA beam scanner being optically coupled to the light source with a programmable switching network and configured to transmit light towards a target with at least one of the optical antennas; wherein one or both of the imaging lens or the FPSA are movable laterally by a displacement step that is smaller than an array pitch of the plurality of optical antennas to increase a lateral resolution of the LiDAR system.

In some aspects, the FPSA is coupled to a translational stage.

In some aspects, the FPSA is coupled to a piezo stage.

In some aspects, the FPSA is coupled to a voice coil motor.

In one aspect, the FPSA is coupled to one or more on-chip MEMS actuators.

In other aspects, the imaging lens is coupled to a translational stage.

In some aspects, the imaging lens is coupled to a piezo stage.

In some aspects, the imaging lens is coupled to a voice coil motor.

In some aspects, the imaging lens comprises a compound imaging lens, wherein one or more pieces of the compound imaging lens are movable.

In other aspects, one or both of the lens or the focal plane switch array are movable laterally in both directions in the 2D plane.

In some aspects, a microlens array is disposed between the imaging lens and the FPSA.

In some aspects, the microlens array is configured to move laterally with respect to one or both of the lens and the focal plane switch array.

In one aspect, the microlens array is coupled to a translational stage.

In some aspects, the microlens array is coupled to a piezo stage.

In one aspect, the microlens array is coupled to a voice coil motor.

An imaging LiDAR system is provided, comprising: an imaging lens; a light source; a focal plane switch array (FPSA) comprising a plurality of optical antennas, the FPSA beam scanner being optically coupled to the light source with a programmable switching network and configured to transmit light towards a target with at least one of the optical antennas; and a movable element coupled to the FPSA to cause the FPSA to be movable laterally by a displacement step that is smaller than an array pitch of the plurality of optical antennas to increase a lateral resolution of the LiDAR system.

In one aspect, the movable element comprises a translational stage.

In another aspect, the movable element comprises a piezo stage.

In some aspects, the movable element comprises a voice coil motor.

In some aspects, the movable element comprises one or more on-chip MEMS actuators.

In one aspect, the imaging lens is coupled to a second movable element.

In some aspects, the second movable element comprises a translational stage.

In one aspect, the second movable element comprises a piezo stage.

In other aspects, the second movable element comprises a voice coil motor.

In some aspects, the movable element is movable laterally in both directions in the 2D plane.

In some aspects, a microlens array is disposed between the imaging lens and the FPSA.

In some aspects, the microlens array is coupled to a second movable element to move the microlens array laterally with respect to one or both of the lens and the focal plane switch array.

In another aspect, the second movable element comprises a translational stage.

In some aspects, the second movable element comprises a piezo stage.

In some aspects, the second movable element comprises a voice coil motor.

A method of LiDAR imaging is provided, comprising the steps of: moving a FPSA beam scanner having N optical antennas to a first imaging position with one or more movable elements; performing a first scan with the FPSA beam scanner to acquire N points of LiDAR measurements; moving the FPSA beam scanner to a second imaging position with the one or more movable elements; performing a second scan with the FPSA beam scanner to acquire N points of LiDAR measurements; and repeating the moving and performing steps for M different positions to acquire N*M measurements for a single LiDAR frame.

In some aspects, the moving step comprises moving the FPSA beam scanner in one direction within a 2D plane.

In some aspects, the moving step comprises moving the FPSA beam scanner in two directions within a 2D plane.

A method of LiDAR imaging is provided, comprising the steps of: moving an imaging lens of a LiDAR system to a first imaging position with one or more movable elements; performing a first scan with a FPSA beam scanner having N optical antennas to acquire N points of LiDAR measurements; moving the imaging lens to a second imaging position with the one or more movable elements; performing a second scan with the FPSA beam scanner to acquire N points of LiDAR measurements; and repeating the moving and performing steps for M different positions to acquire N*M measurements for a single LiDAR frame.

In some aspects, the moving step comprises moving the imaging lens in one direction within a 2D plane.

In some aspects, the moving step comprises moving imaging lens in two directions within a 2D plane.

A method of LiDAR imaging is provided, comprising the steps of: moving a microlens array of a LiDAR system to a first imaging position with one or more movable elements; performing a first scan with a FPSA beam scanner having N optical antennas to acquire N points of LiDAR measurements; moving the microlens array to a second imaging position with the one or more movable elements; performing a second scan with the FPSA beam scanner to acquire N points of LiDAR measurements; and repeating the moving and performing steps for M different positions to acquire N*M measurements for a single LiDAR frame.

In some aspects, the moving step comprises moving the microlens array in one direction within a 2D plane.

In some aspects, the moving step comprises moving microlens array in two directions within a 2D plane.

### BRIEF DESCRIPTION OF THE DRAWINGS

The novel features of the invention are set forth with particularity in the claims that follow. A better understanding of the features and advantages of the present invention will be obtained by reference to the following detailed description that sets forth illustrative embodiments, in which the principles of the invention are utilized, and the accompanying drawings of which:

FIG. 1 shows output beam directions from two adjacent antennas on a focal plane switch array.

FIG. 2A shows the angular resolution can be increased by shifting the focal plane switch array chip laterally with a step smaller than p.

FIG. 2B shows the angular resolution can be increased by shifting the imaging lens laterally with a step smaller than p.

FIG. 3A shows the lateral displacement of the FPSA chip may be in both directions in the 2D plane.

FIG. 3B shows the lateral displacement of the lens may be in both directions in the 2D plane.

FIG. 4A illustrates one example of increasing lateral resolution by shifting a microlens array.

FIG. 4B shows an example of a FPSA chip and a microlens array that can be shifted together to increase lateral resolution.

FIG. 5 shows an example of a LiDAR system timing diagram using a focal plane switch array with increased angular resolution by shifting the antenna array, lens, or microlens array.

FIG. 6 shows an example of a LiDAR system timing diagram with a dithering antenna array, lens, or microlens to mitigate speckle effects.

FIGS. 7A-7C show a system that includes a 16,384-pixel FPSA with diffraction-limited beam (divergence=0.05°) over a 70°×70°FOV.

FIGS. 8A-8B show a schematic of a system that includes continuously scannable (CS) FPSA with a programmable optical switch network that provides coarse steering while scanning a microlens array to provide fine steering over 120° when used in conjunction with a wide-angle metalens.

FIGS. 9A-9F show microscopic images of a 128×128 array with 16,384 pixels.

FIGS. 10A-10D show schematic structures and the confocal microscope measurement of one embodiment of Si photonic switches.

FIGS. 11A-11C show simulation results of a microlens with a diameter of 60 μm and a radius of 110 μm on a 250-μm-thick Si.

FIG. 12 shows a microlens scanner configured to compensate for vibration of an optical receiver placed on a shaker table.

FIGS. 13A-13G compare the performance of a traditional lens (FIG. 13A) and a metalens (FIG. 13C).

### DETAILED DESCRIPTION

This disclosure provides LiDAR systems and methods that improve the angular resolution of a focal plane switch array by small displacement of the array chip, imaging lens, or microlens. This disclosure further provides LiDAR systems and methods for mitigating speckle effects on a focal plane switch array by small dithering of the array chip, imaging lens, or microlens.

This disclosure also provides a novel silicon photonic beam-steering system that will dramatically reduce the size, weight, and power (SWaP) of optical beam-steering systems in free-space optical communications (FSOC) and light detection and ranging (LiDAR). Typically, optical beam-steering is accomplished by gimbals or motors. Such systems are too expensive, bulky, and heavy for many emerging applications in small autonomous vehicles. Solid state beam-steering devices are provided with fine pointing resolution (0.02°) over wide field of views (FOVs=120°), fast response times (<100 μs), and diffraction-limited beam quality for FSOC and LiDAR.

This disclosure also provides a novel continuously scannable focal plane switch array (CS-FPSA) to address these challenges. FPSA uses a camera-like optical system that maps each angle within the FOV to a pixel at the back focal plane of an imaging lens. Each pixel can be an optical antenna (grating coupler) and an optical switch that delivers the received optical signal to a common detector.

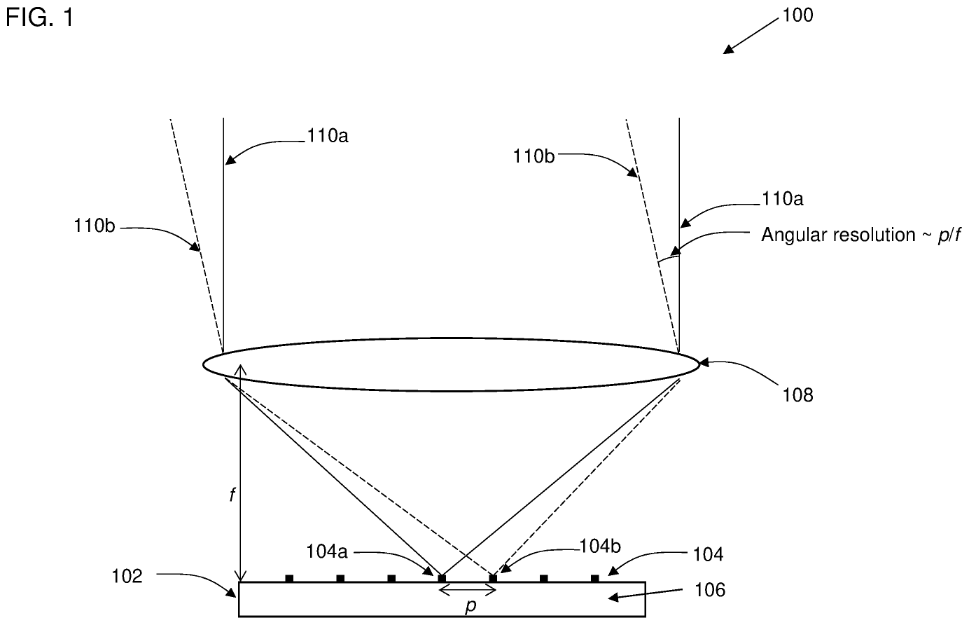

FIG. 1 shows a LiDAR system 100 that includes a focal plane switch array (FPSA) beam scanner 102. The FPSA beam scanner 102 can include an array of optical antennas 104 spaced apart by an array pitch p that are optically connected to a programmable optical switch network 106 and configured to output an optical signal through a lens 108 positioned at a focal length f from the array of optical antennas. Additional details on a programmable optical switch network can be found in U.S. Pat. No. 11,754,683, which is incorporated herein by reference in its entirety. When different optical antennas are selected, the output beams are directed to different directions. For example, antenna 104a has an output beam 110a, and antenna 104b has an output beam 110b. The beam scanning directions are discrete, and the angular resolution is approximately p/f.

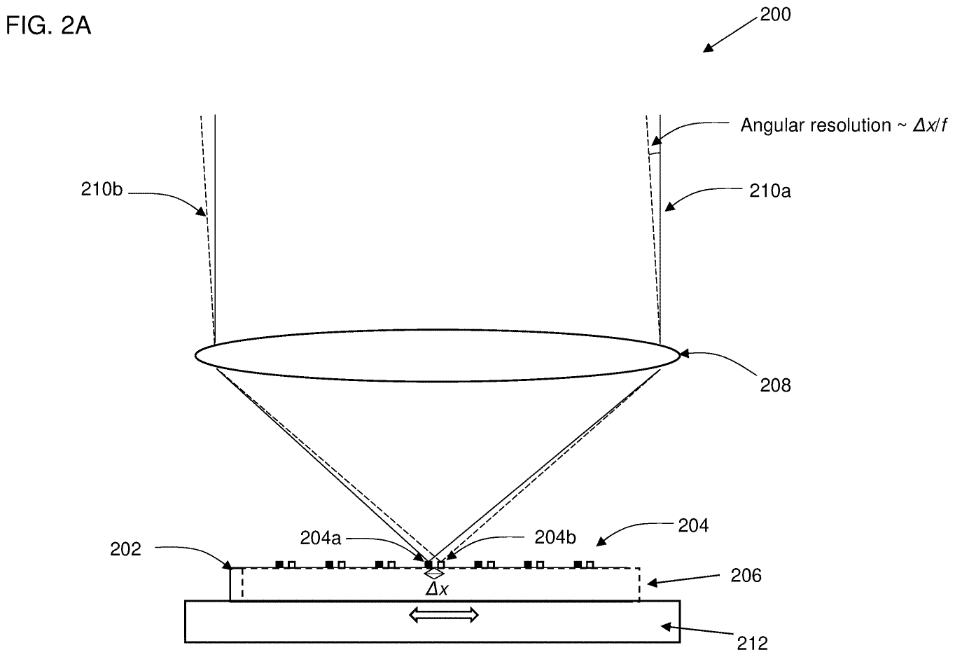

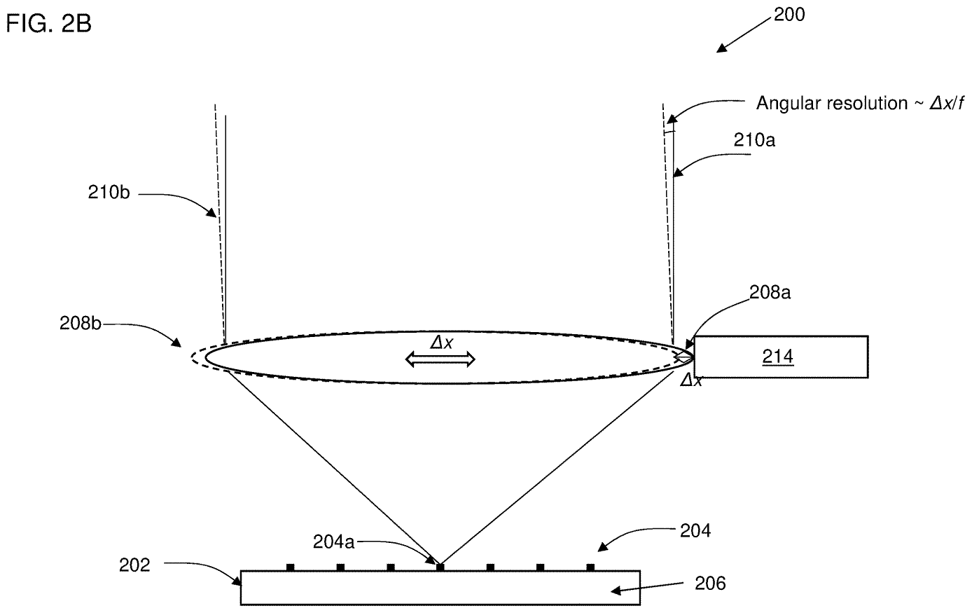

FIG. 2A shows the angular resolution of the LiDAR system 200 can be increased by shifting the FPSA beam scanner 202 laterally with a step smaller than p. The system 200 can include the same components described above, including a FPSA beam scanner 202, an array of optical antennas 204, a programmable optical switch network 206, and an imaging lens 208. For a displacement step of Δx, the angular resolution is improved to Δx/f. The maximum displacement needed is the array pitch p, which is usually tens of micrometers. This small displacement can be realized by mounting the FPSA beam scanner 202 and/or the individual optical antennas on a movable element 212 such as a translational stage, a piezo stage, a voice coil motor, or other types of stages, or by on-chip MEMS actuators. Antenna 204a and output beam 210a correspond to an antenna and output beam before translating the FPSA beam scanner laterally, and antenna 204b and output beam 210b shows the same antenna and output beam after the FPSA beam scanner is translated laterally by a step distance Δx.

FIG. 2B shows the angular resolution can be increased by shifting the imaging lens 208 laterally with a step smaller than p. The system 200 can include the same components described above, including a FPSA beam scanner 202, an array of optical antennas 204, a programmable optical switch network 206, and an imaging lens 208. For a displacement step of Δx, the angular resolution through lens 208 is improved to Δx/f. The maximum displacement needed is the array pitch p, which is usually tens of micrometers. This small displacement can be realized by mounting or attaching the imaging lens 208 on/to a movable element 214 translational stage, a piezo stage, a voice coil motor, or other types of stages, or by moving one or several pieces of lenses in a compound imaging lens. Antenna 204a and output beam 210a correspond to an antenna and output beam before translating the imaging lens laterally, and antenna 204b and output beam 210b shows the same antenna and output beam after the lens is translated laterally by a step distance Δx.

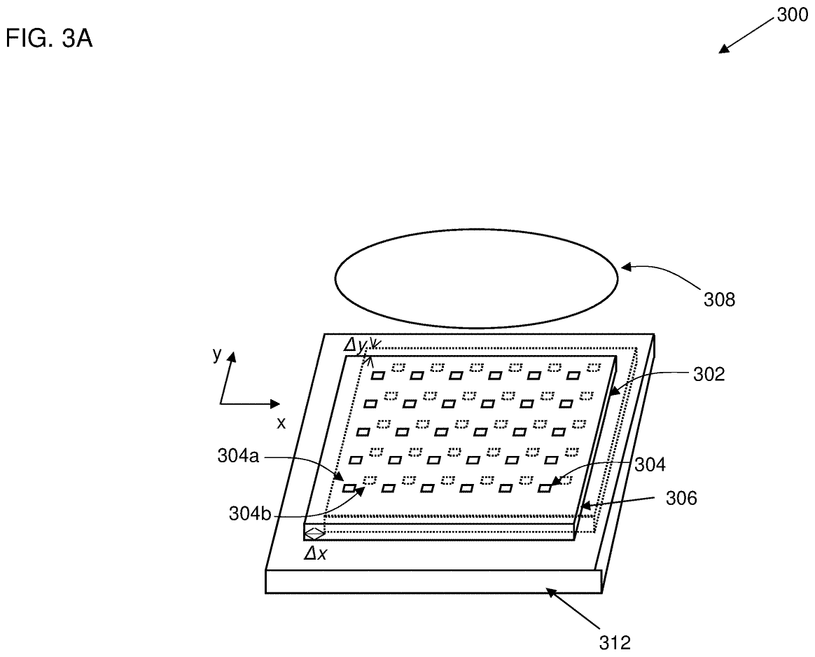

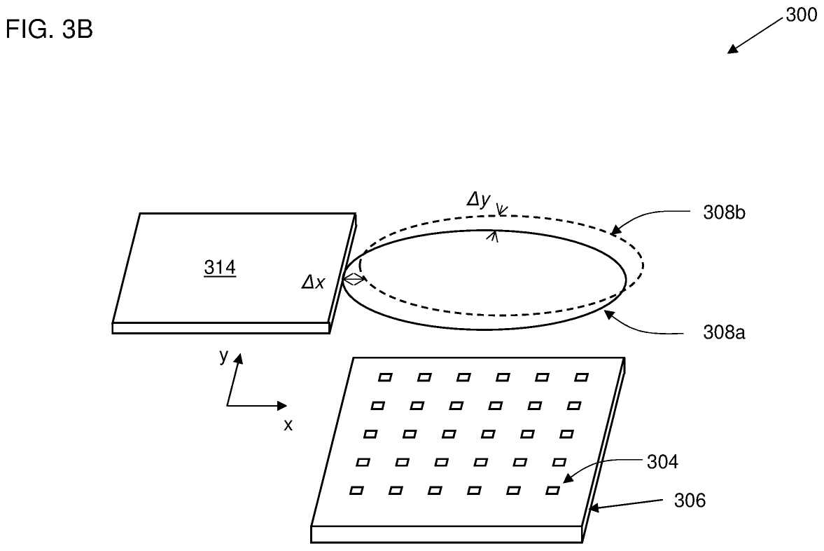

FIG. 3A shows another LiDAR system 300 in which the lateral displacement of the FPSA beam scanner 302 may be in both directions in the 2D plane (e.g., x and y directions). The system 300 can include the same components described above, including a FPSA beam scanner 302, an array of optical antennas 304, a programmable optical switch network 306, and an imaging lens 308. Optical antenna 304a represents an antenna prior to lateral displacement, and optical antenna 304b represents the same antenna after lateral displacement in both directions. For a displacement step of Ax in the x direction and Ay in the y direction, the angular resolution is improved to Δx/f and Δy/f, in the two directions respectively. This two-direction displacement can be realized by mounting the focal plane switch array chip on a movable element 312 such as a translational stage, a piezo stage, a voice coil motor, or other types of stages, or by on-chip MEMS actuators.

FIG. 3B shows another LiDAR system 300 in which the lateral displacement of the lens may be in both directions in the 2D plane. The system 300 can include the same components described above, including a FPSA beam scanner 302, an array of optical antennas 304, a programmable optical switch network 306, and an imaging lens 308. For a displacement step of Δx in the x direction and Δy in the y direction, the angular resolution is improved to Δx/f and Δy/f, in the two directions respectively. This two-direction displacement can be realized by mounting the imaging lens on movable element 314 such as a translational stage, a piezo stage, a voice coil motor, or other types of stages, or by moving one or several pieces of lenses in a compound imaging lens.

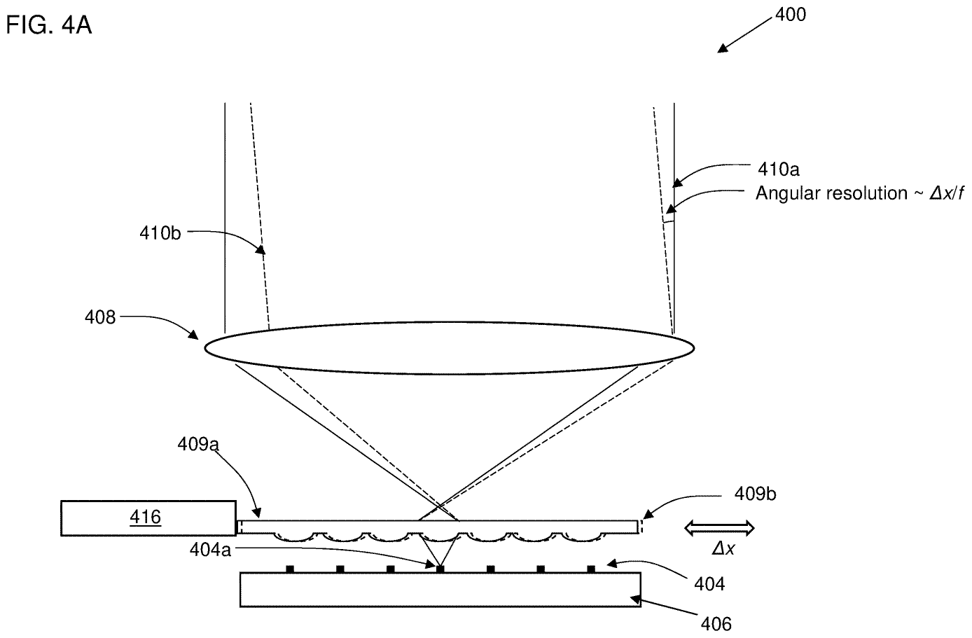

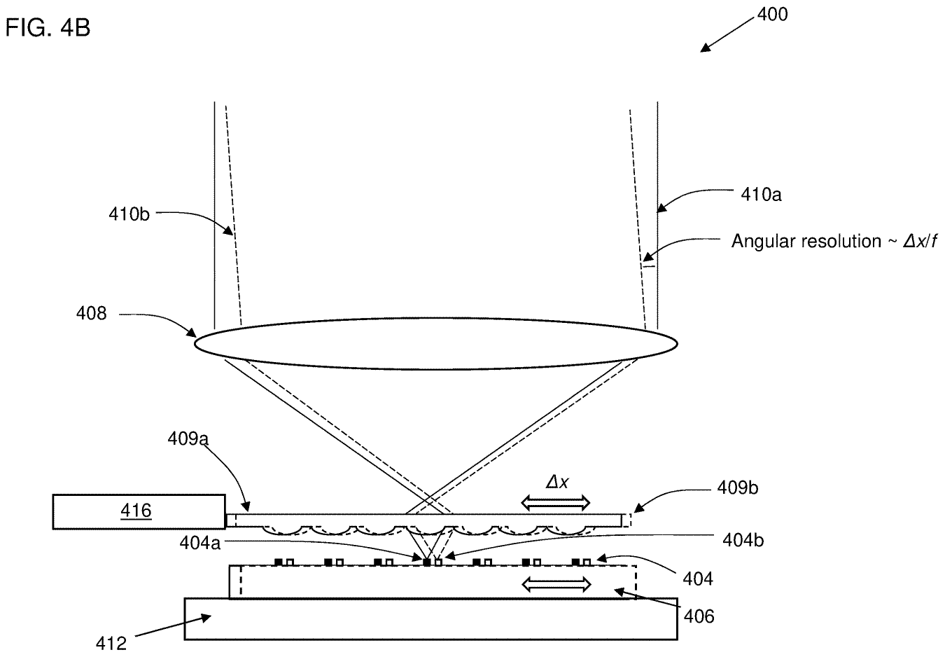

FIG. 4A shows another example of a LiDAR system 400. The system 400 can include the same components described above, including a FPSA beam scanner 402, an array of optical antennas 404, a programmable optical switch network 406, an imaging lens 408, and a microlens array disposed between the FPSA beam scanner and the imaging lens. For a focal plane switch array with microlens, in addition to shifting the focal plane switch array chip or the imaging lens, the angular resolution can also be increased by shifting the microlens array, as shown in FIG. 4A. Microlens 409a represents the position of the microlens array before lateral shifting, and microlens 409b represents the position of the microlens array after lateral shifting. Output beam 410a is the output beam of optical antenna 404a before the microlens is shifted, and output beam 410b is the output beam of optical antenna 404a after the microlens is shifted. The displacement depends on the microlens design. As an example, if the microlens is designed to have equal object and image distances, for a microlens displacement step of Δx, the angular resolution is improved to 2Δx/f. This displacement can be realized by mounting the microlens array on a movable element 416 such as a translational stage, a piezo stage, a voice coil motor, or other types of stages, or by on-chip MEMS actuators.

In some embodiments, the FPSA beam scanner and microlens array may be shifted together, as shown in FIG. 4B. Optical antenna 404a represents the position of an optical antenna before lateral shifting, and optical antenna 404b represents the position of the same optical antenna after lateral shifting. Output beam 410a is the output beam of optical antenna 404a, and output beam 410b is the output beam of optical antenna 404b after the lateral shift (of the microlens and/or FPSA beam scanner). For a microlens and FPSA chip displacement step of Δx, the angular resolution is improved to Δx/f. This displacement can be realized by mounting the microlens array and FPSA chip on movable elements 416 and 412, respectively, such as a translational stage, a piezo stage, a voice coil motor, or other types of stages.

The displacements of microlens array and/or FPSA chip shown in FIGS. 4A and 4B may also be in both directions in the 2D plane, as described herein (e.g., FIGS. 3A-3B).

In additional to shifting the FPSA beam scanner, the imaging lens, or the microlens in small steps to increase the angular resolution as mentioned above, such displacement may also be continuous (for example, a sinusoidal dithering), so the beam direction is slightly changed during one point of LiDAR measurement. This will help vary the laser speckle pattern and mitigate the speckle effects on the received signal power. The continuous dithering may be superimposed on the discrete shift of the FPSA chip/lens/microlens as described above.

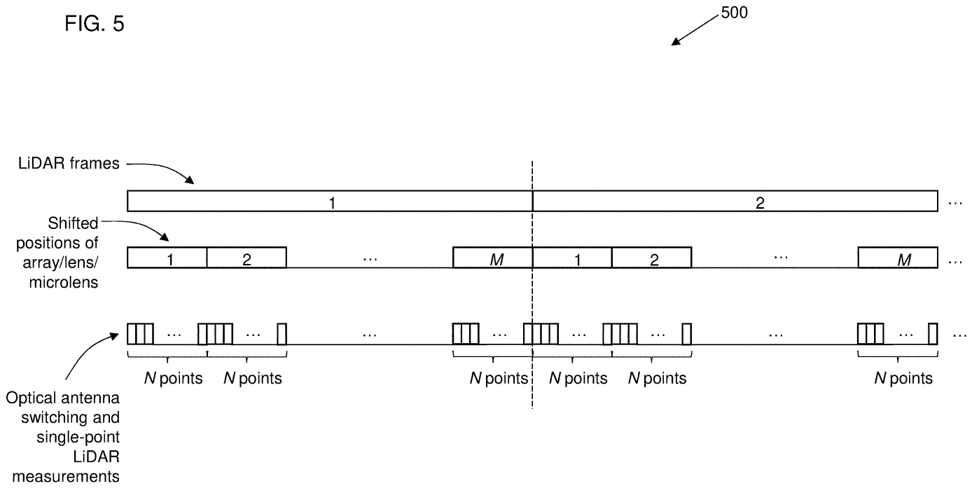

FIG. 5 shows an example of the LiDAR system timing diagram 500 with improved angular resolution. The timing scheme illustrated in FIG. 5 can be used with any of the LiDAR system embodiments described herein. Assuming the focal plane switch array of the LiDAR system has N optical antennas, and the FPSA beam scanner, imaging lens, or microlens can be shifted to M different positions (in one direction or two directions), the output beam can then be directed to N*M different directions in the field of view.

In each LiDAR frame, when the array/lens/microlens is shifted to position #1, the focal plane switch array can perform a scan to acquire N points of LiDAR measurements (for position #1). Then the array/lens/microlens can be shifted to the next position #2, and the focal plane switch array can perform another scan to acquire another N points of LiDAR measurements (for position #2). This can be repeated until the array/lens/microlens is shifted to all M positions and total N*M LiDAR measurements are acquired to complete one LiDAR frame. Then the next LiDAR frame starts and the same procedure repeats.

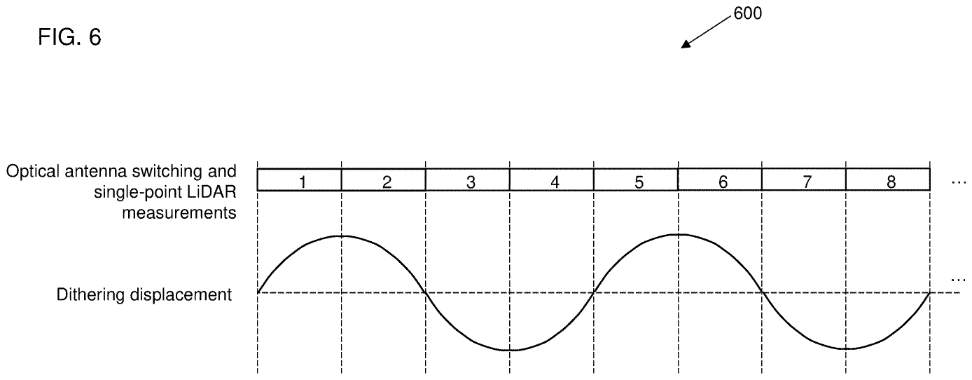

FIG. 6 shows an example of a timing diagram 600 with a dithering array/lens/microlens to mitigate speckle effects. This dithering displacement can be implemented on top of the discrete displacement for improving resolution, or it can be implemented independently. The step displacement and dithering can be combined to move the same component (e.g., the focal plane switch array chip, the imaging lens, or the microlens), or they can be achieved separately on two different components. In the example shown in FIG. 6, the lateral displacement (dithering displacement) vs. time is sinusoidal, and four points of LiDAR measurements are performed within one dithering period.

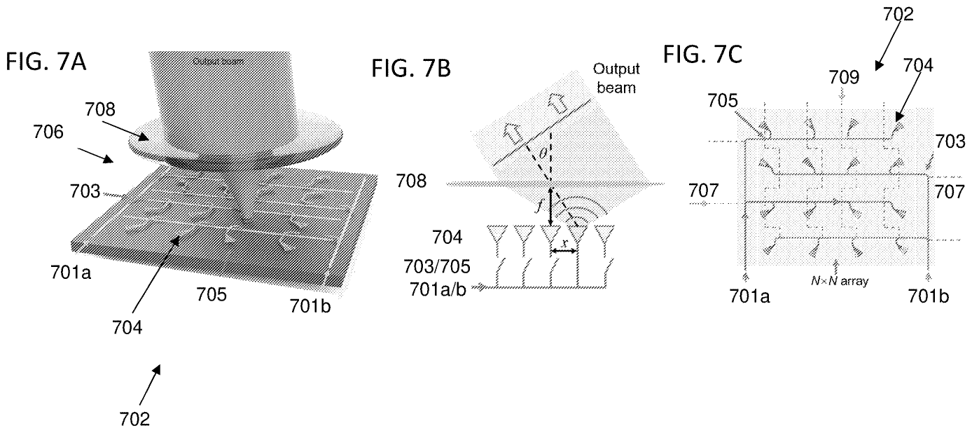

FIGS. 7A-7C show a system that includes a 16,384-pixel FPSA 702 with diffraction-limited beam (divergence=0.05°) over a 70°×70°FOV. The FPSA can have an array of optical antennas 704 with a programmable optical switch network 706 that includes row selection switches 703 and column selection switches 705. One or more inputs (701a, 701b, etc.) can provide optical signals to the programmable optical switch network. The array of optical antennas 704 can transmit optical signals through the imaging lens 708 to produce an output beam, as shown in FIG. 7A.

FIG. 7B is a schematic view of the system of FIG. 7A. FIG. 7C is another view of the FPSA 702 that shows how row selection signals 707 and column selection signals 709 can operate row selection switches 703 and column selection switches 705, respectively, to direct an optical signal from one or more inputs 701a/b to a selected optical antenna 704.

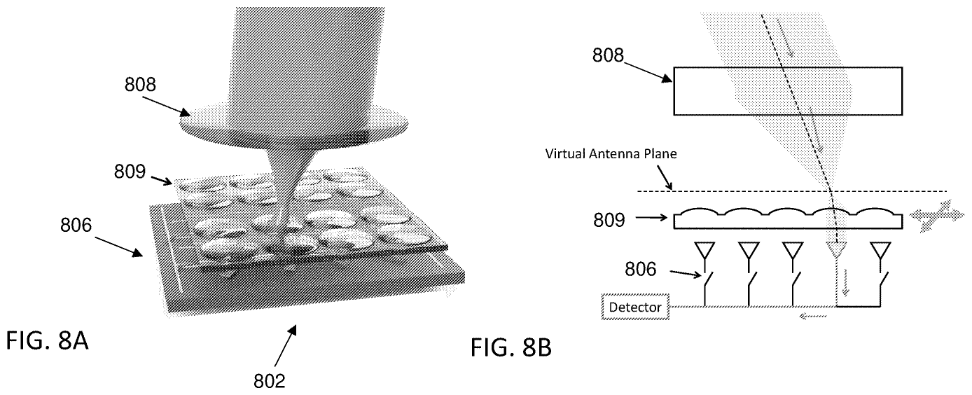

The performance goals of the embodiment shown in FIGS. 7A-7C can be satisfied with a 100-pixel (10×10 array) FPSA with a pitch of 60 μm and an imaging lens with 520 μm focal length and 370 μm aperture. In this example the angular resolution is 6.6°i. Since FPSA is a highly scalable chipscale technology, a 24,000-pixel FPSA that will produce a 51°×32°FOV and an angular resolution of 0.26°. The embodiment of FIGS. 8A-8B can be implemented by combining (1) a 1,000,000-pixel FPSA for coarse steering (0.12° angular resolution), (2) scanning microlens array for fine steering (<0.02° resolution), and (3) a novel wide-angle metalens with 120° FOV and 10-mm aperture.

In some embodiments, the FPSA shown in FIGS. 7A-7C can be provided together with a commercial imaging lens with a focal length of 12.5 mm and F/1.4. The FPSA can comprise a two-dimensional (2D) array of optical antennas (grating couplers) connected to common input ports through an optical switch network. Each optical antenna can be mapped to an unique beam angle in the far field though the imaging lens: θᵢ=tan⁻1(−xᵢ/ƒ) where xᵢ is the location of the optical antenna in the i^{th} pixel, ƒ is the focal length of the imaging lens, and θᵢ is the beam angle. The received optical signal can be routed to the common detector by turning on the corresponding column and row selections switches.

FIGS. 8A-8B show a schematic of a system that includes continuously scannable (CS) FPSA 802 with a programmable optical switch network 806 that provides coarse steering while scanning a microlens array 809 to provide fine steering over 120° when used in conjunction with a wide-angle metalens 808. FIG. 8B is a schematic view of the same system.

The design of FIGS. 8A-8B includes a microlens array between the FPSA and the imaging lens. The microlens creates an image of the optical antenna at the focal plane of the microlens. The image can be shifted laterally by physically moving the microlens, which can cause the far-field angle to steer around the coarse beam position. Since only a very small displacement (~10 μm) is needed, this movement can be achieved by integrated MEMS actuators with fast response time (<100 μs). This fine steering stage can seamlessly bridge the gaps between the coarse beam angles set by FPSA. For a single beam (SOAR), the microlens array can be moved on a common platform. The CS-FPSA architecture can be extended to simultaneously transmit/receive (Tx/Rx) and multiple beam operation.

The FPSA chips provided herein offers many advantages over other chip scale beam-steering devices such as optical phased array antenna (OPA). OPA is generally limited to 1D arrays (scanning in the other direction is achieved by wavelength tuning, which does not work for receiver). The large number of high precision analog control signals and sub-wavelength element spacing are additional challenges. In contrast, the FPSA with N×M array only requires 2D digital control signals, which can be easily achieved standard control electronics.

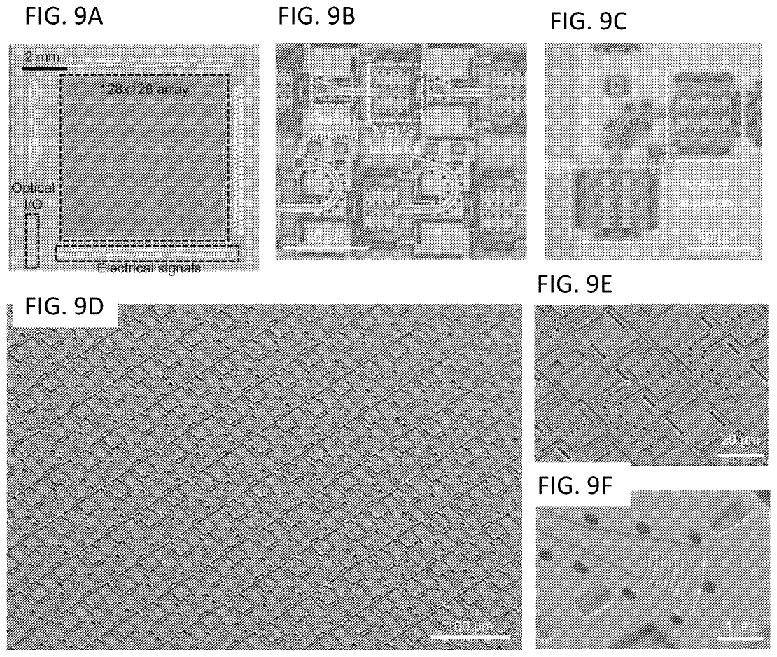

The FPSA chips of the present disclosure have been experimentally demonstrated. FIGS. 9A-9F show microscopic images of a 128×128 array with 16,384 pixels. The FPSA can be implemented on a silicon photonic die with an area of 1 cm×1 cm. The active imaging area can be 7 mm×7 mm. As mentioned in the previous section, this FPSA can provide a 32× higher resolution over other known devices.

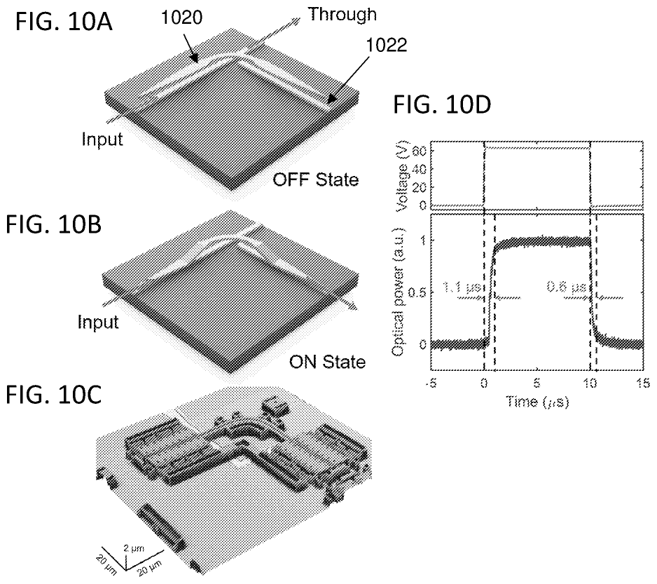

This unprecedented performance is achieved through the use of silicon photonic MEMS switches. The schematic structure and the confocal microscope measurement of one embodiment of Si photonic switches is shown in FIGS. 10A-10D. A coupler waveguide 1020 can be pulled down to within 100 nm of a bus waveguide 1022 to transition from the OFF state (FIG. 10A) to the ON state (FIG. 10B). The MEMS switches of this embodiment have a much smaller footprint (~20 μm×20 μm) than traditional Mach-Zehnder interferometer (MZI)-based switches with several hundred micrometers in length. In addition, the insertion loss in the OFF state is extremely low (<0.001 dB), making it possible to cascade hundreds, or even thousands, of switches along the bus waveguide without excessive loss. In contrast, typical MZI switch has ~0.25 dB loss per stage, which means 100 cascaded switches have 25 dB loss. With 1 1-μs switching time (FIG. 4d), the Si photonic MEMS switch is also ~100×faster than thermos-optic MZI switches.

### (a) Continuous Scanning Microlens Array

In one embodiment, the resolution of the FPSA can be increased to 1 million pixels (1000×1000). The discrete scanning step, 120°/1000=0.12°, is larger than the diffraction limit. Therefore, a fine-scanning stage can be added to achieve a finer angular resolution, which in this example would be 0.022°(=2×1.22×1.55/10000 radian). A laterally movable microlens array can be used as shown in FIGS. 8A-8B for continuous scanning.

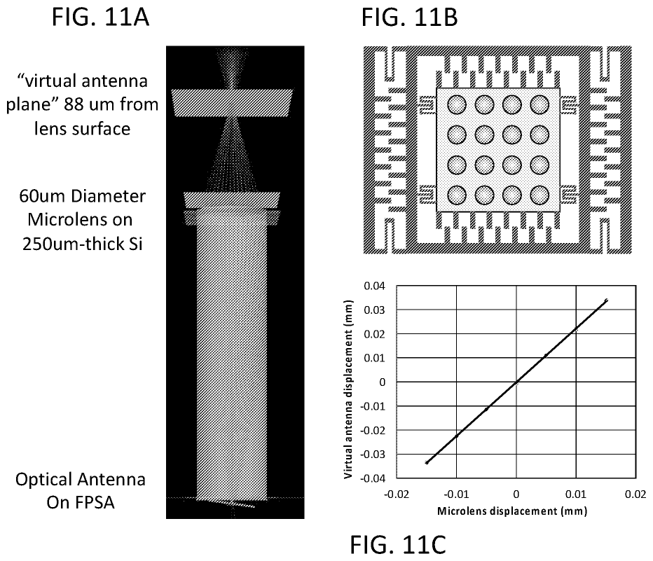

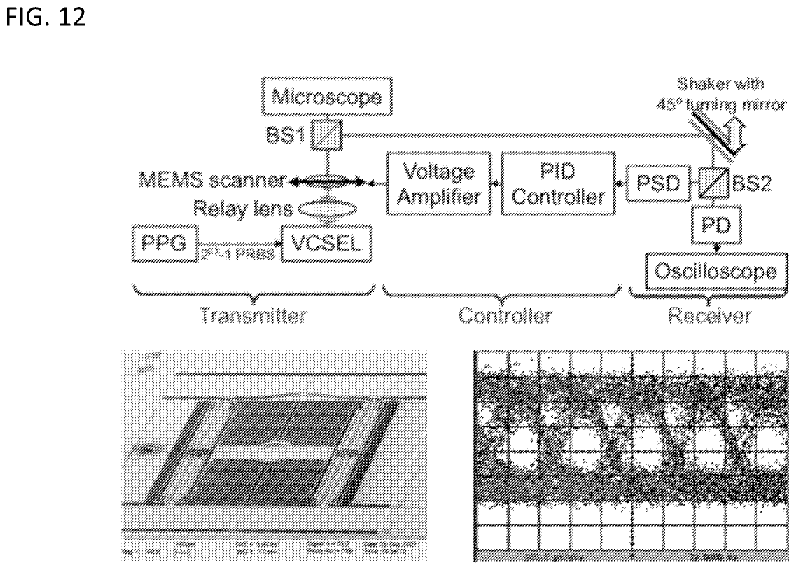

FIGS. 11A-11C show simulation results of a microlens with a diameter of 60 μm and a radius of 110 μm on a 250-um-thick Si. A virtual image of the optical antenna is formed at 88 μm from the lens surface. This virtual antenna can be shifted by moving the microlens laterally. A 10 μm displacement is sufficient to move the virtual antenna by 20 μm. The microlens scanner can successfully compensate for vibration of the optical receiver placed on a shaker table, restoring open eye diagrams (FIG. 12). The entire microlens array can be actuated simultaneously. Here, electrostatic comb drive actuators can be used for moving the microlens in two directions. Though FPSA is capable of receiving multiple beams by multiplexing with multiple detectors, the single microlens array scanner limits the number of receive beams to one. To restore the capability to receive multiple beams, the microlens scanners can be individually addressable. This can be achieved by integrating individually actuated microlens scanners with a CMOS row/column addressing circuits.

### (b) Wide FOV Metalens:

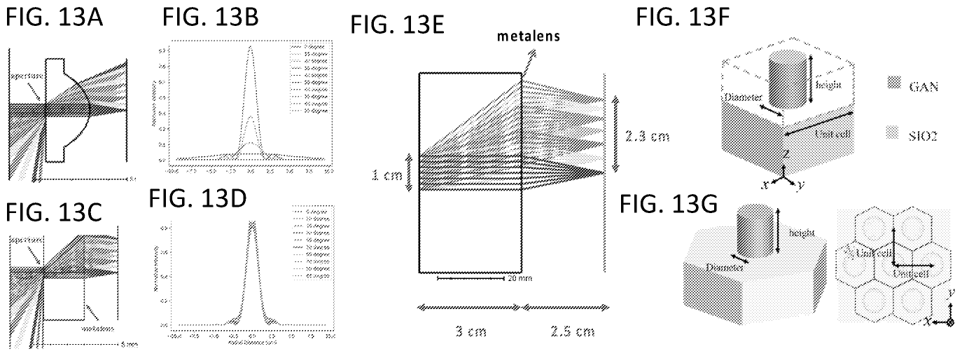

It can be challenging for a conventional lens to provide both wide FOV (120°) and large aperture (10 mm). A diffraction-limited FOV of over 170° can be achieved a wide-angle metalens with a numerical aperture of 0.25. FIGS. 13A-13G compare the performance of a traditional lens (FIG. 13A) and a metalens (FIG. 13C). FIGS. 13A-13B show a conventional lens, FIGS. 13C-13D show a wide-angle metalens. FIG. 13E is a design of a wide-angle microlens with 120° FOV and 10-mm aperture. FIGS. 13F-13G show a metalens with a square and a hexagonal unit cells, respectively. Here GaN can be used as the high index material. For 1550 nm, Si can be used for ease of fabrication. It is clear that the metalens delivers superior performance for large steering angles. FIG. 13E shows the design of a preliminary wide-angle metalens with an FOV of 120° and an aperture of 10 mm. In one embodiment, the FPSA can have a chip size of 2×2.3 cm=4.6 cm. Though this chip size is larger than the reticle of typical lithography equipment, Si photonic dies can be lithographically stitched across die boundaries with negligible loss (<0.004 dB). Using such wafer-scale integration, this disclosure has demonstrated record large Si photonic switches (240×240) on a 4 cm×4 cm die.

### (c) Simultaneous Transmit and Receive (TxRx)

The FPSA discussed above can be capable of simultaneously transmitting a modulated laser beam and receiving the reflected beam from the targets. The same optical antenna in each pixel can then be used for both transmitting and receiving optical signals. The signals can be separated off-chip by an optical circulator. However, an optical circulator can be difficult to integrate on chip and in some embodiments, a FPSA is provided with separate transmit and receive antennas in each pixel. This allows separation of the transmit and receive signals without circulators.

As for additional details pertinent to the present invention, materials and manufacturing techniques may be employed as within the level of those with skill in the relevant art. The same may hold true with respect to method-based aspects of the invention in terms of additional acts commonly or logically employed. Also, it is contemplated that any optional feature of the inventive variations described may be set forth and claimed independently, or in combination with any one or more of the features described herein. Likewise, reference to a singular item, includes the possibility that there are plural of the same items present. More specifically, as used herein and in the appended claims, the singular forms “a,” “and,” “said,” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Unless defined otherwise herein, all technical and scientific terms used herein have the same meaning as commonly understood by one of ordinary skill in the art to which this invention belongs. The breadth of the present invention is not to be limited by the subject specification, but rather only by the plain meaning of the claim terms employed.

1. An imaging LiDAR system comprising:
an imaging lens;
a light source;
a focal plane switch array (FPSA) comprising a plurality of optical antennas, the FPSA beam scanner being optically coupled to the light source with a programmable switching network and configured to transmit light towards a target with at least one of the optical antennas;
wherein one or both of the imaging lens or the FPSA are movable laterally by a displacement step that is smaller than an array pitch of the plurality of optical antennas to increase a lateral resolution of the LiDAR system.

2. The system of claim 1, wherein the FPSA is coupled to a translational stage.

3. The system of claim 1, wherein the FPSA is coupled to a piezo stage.

4. The system of claim 1, wherein the FPSA is coupled to a voice coil motor.

5. The system of claim 1, wherein the FPSA is coupled to one or more on-chip MEMS actuators.

6. The system of claim 1, wherein the imaging lens is coupled to a translational stage.

7. The system of claim 1, wherein the imaging lens is coupled to a piezo stage.

8. The system of claim 1, wherein the imaging lens is coupled to a voice coil motor.

9. The system of claim 1, wherein the imaging lens comprises a compound imaging lens, wherein one or more pieces of the compound imaging lens are movable.

10. The system of claim 1, wherein one or both of the lens or the focal plane switch array are movable laterally in both directions in the 2D plane.

11. The system of claim 1, further comprising a microlens array disposed between the imaging lens and the FPSA.

12. The system of claim 11, wherein the microlens array is configured to move laterally with respect to one or both of the lens and the focal plane switch array.

13. The system of claim 1, wherein the microlens array is coupled to a translational stage.

14. The system of claim 1, wherein the microlens array is coupled to a piezo stage.

15. The system of claim 1, wherein the microlens array is coupled to a voice coil motor.

16.-39. (Canceled)
